(19) United States
(12) Patent Application Publication
(10) Pub. No.: US 2013/0066902 A1
(43) Pub. Date: Mar. 14, 2013

(54) INFORMATION PROCESSING APPARATUS, INFORMATION PROCESSING METHOD, AND COMPUTER-READABLE STORAGE MEDIUM

(71) Applicants: Takayuki Iida, Tachikawa-shi (JP); Sumi Omura, Mitaka-shi (JP); Kentaro Nagahama, Tachikawa-shi (JP); Makito Ogura, Hino-shi (JP); Kensuke Horiuchi, Kunitachi-shi (JP)

(72) Inventors: Takayuki Iida, Tachikawa-shi (JP); Sumi Omura, Mitaka-shi (JP); Kentaro Nagahama, Tachikawa-shi (JP); Makito Ogura, Hino-shi (JP); Kensuke Horiuchi, Kunitachi-shi (JP)

(21) Appl. No.: 13/460,386

(22) Filed: Apr. 30, 2012

(30) Foreign Application Priority Data
Sep. 8, 2011 (JP) 2011-196549

(51) Int. Cl. G06F 17/30; G06F 17/00

(52) U.S. Cl. 707/769; 715/234; 707/E17.014

(57) ABSTRACT

According to one embodiment, an information processing apparatus includes a content display, an extraction module, and a keyword display. The content display is configured to display a content. The extraction module is configured to extract a keyword from the content displayed by the content display. The keyword display is configured to display the keyword extracted by the extraction module in a content display window.

### CROSS-REFERENCE TO RELATED APPLICATIONS

This application is based upon and claims the benefit of priority from prior Japanese Patent Application No. 2011-196549, filed Sep. 8, 2011, the entire contents of which are incorporated herein by reference.

### FIELD

Embodiments described herein relate generally to an information processing apparatus that searches for information, an information processing method, and a computer-readable storage medium.

### BACKGROUND

A large number of web sites including one or a plurality of web pages (hereinafter, also called contents) are connected to the Internet. An information processing apparatus connected to the Internet can provide various kinds of information to users by accessing web pages. A web page corresponds to a file described in HTML (HyperText Markup Language) and is identified by a URI (Uniform Resource Indicator) or a URL (Uniform Resource Locator) (hereinafter, called a URI). Since many web pages can be accessed, it is difficult for a user of an information processing apparatus to find a useful web page. Incidentally, search engines that search for web pages based on input keywords after such keywords being input are frequently used. However, no matter how capable a search engine is, desired information cannot be obtained if suitable keywords are not input.

Thus, extracting keywords related to a content from the currently displayed content and displaying the extracted keywords can be considered.

A conventional information processing apparatus displays keywords extracted from the display content in a dedicated display area separate from display windows of content. Thus, displayed keywords may be hidden depending on the display mode of content.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an information processing apparatus according to an embodiment.

FIG. 2 is an exemplary block circuit diagram showing a system of the information processing apparatus.

FIG. 3 is an exemplary flow chart showing a flow of search processing by the information processing apparatus.

FIG. 4 is an exemplary diagram showing a screen display according to a first embodiment.

FIG. 5 is an exemplary diagram showing another screen display according to the first embodiment.

FIG. 6 is an exemplary diagram showing a screen display according to a second embodiment.

FIG. 7 is an exemplary diagram showing a screen display according to a third embodiment.

FIG. 8 is an exemplary diagram showing a screen display according to a fourth embodiment.

FIG. 9 is an exemplary diagram showing a screen display according to a fifth embodiment.

FIG. 10 is an exemplary diagram showing a screen display according to a sixth embodiment.

FIG. 11 is an exemplary diagram showing a screen display according to a seventh embodiment.

FIG. 12 is an exemplary diagram showing a screen display according to an eighth embodiment.

### DETAILED DESCRIPTION

### First Embodiment

Various embodiments will be described hereinafter with reference to the accompanying drawings.

In general, according to one embodiment, an information processing apparatus includes a content display; an extraction module; and a keyword display. The content display is configured to display a content. The extraction module is configured to extract a keyword from the content displayed by the content display. The keyword display is configured to display the keyword extracted by the extraction module in a content display window.

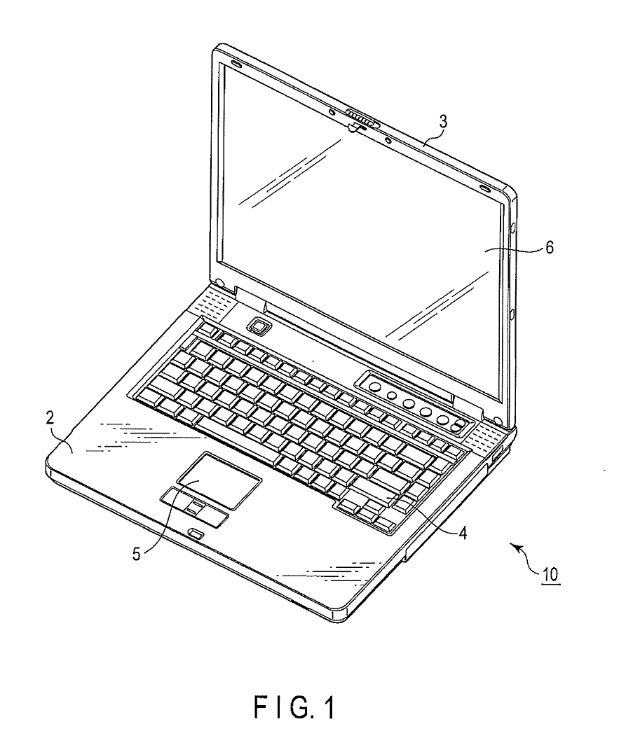

FIG. 1 is a diagram showing an example of appearance of an information processing apparatus according to an embodiment. The information processing apparatus is realized as, for example, a battery-operable notebook-type personal computer (PC) 10. However, the form of the information processing apparatus is not limited to the notebook-type personal computer and may be any form such as a desktop-type personal computer, a slate-type or tablet-type portable information terminal, or a mobile phone.

FIG. 1 is a perspective view when a display 3 of the PC 10 is opened. The PC 10 includes a computer main body 2 and the display 3. A liquid crystal display panel (LCD) 6 is installed in the display 3 and the display surface of the LCD 6 is positioned approximately in the center of the display 3.

The display 3 is attached to the computer main body 2 so as to be freely rotatable between an open position in which the top surface of the computer main body 2 is exposed and a closed position in which the top surface of the computer main body 2 is covered. The computer main body 2 is a unit having a thin box-shaped cabinet and a keyboard 4, a pointing device 5 and the like are arranged on the top surface thereof.

A local area network (LAN) controller performing communication by wire conforming to, for example, the IEEE 802.3 standard and a wireless LAN controller performing wireless communication conforming to, for example, the IEEE 802.11n standard are provided inside the computer main body 2. Thus, the PC 10 can access web sites on the Internet regardless of indoors or outdoors.

The keyboard 4 and the pointing device 5 are devices that take charge of the input side of a user interface provided by the PC 10, and the LCD 6 is a device that takes charge of the output side of the user interface provided by the PC 10. For example, various programs loaded from a hard disk drive (HDD) into a main memory and executed by a processor (CPU) receive a user instruction via the keyboard 4 or the pointing device 5 and present a result of processing performed based on the user instruction to the user via the LCD 6. In addition to the operating system (OS) that performs resource management and the basic input and output (BIOS) system to control hardware, application programs including browsers to browse web pages operating under the control of the OS and utility programs are present among various programs.

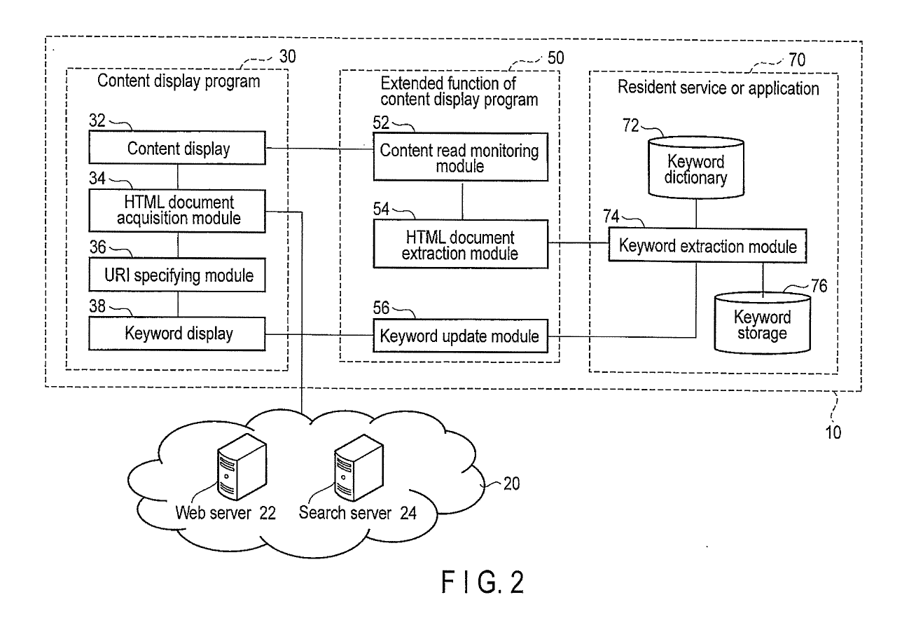

FIG. 2 is a block diagram showing a system configuration related to web page browsing of the PC 10. The PC 10 includes a content display program 30, an extended function 50 thereof, and a resident service or an application 70. The Internet 20 to which the PC 10 is connected is provided with a web server 22 and search server 24. The search server 24 is not limited to one search engine and may contain a plurality of search engines to allow the user to select the search engine to be used. Further, the language of keywords may be made specifiable.

The content display program 30 is a program to browse web pages offered for public viewing by web sites on the Internet 20 and includes a URI specifying module 36, an HTML document acquisition module 34, a content display 32, and a keyword display 38. The HTML document acquisition module 34 acquires web pages from the web server 22 according to the URI specified by the URI specifying module 36. The content display 32 displays an acquired web page screen in the LCD 6. The keyword display 38 is a user interface such as a status bar area, toolbar area, and side bar area of the content display program 30.

The extended function (add-on) 50 of the content display program includes a content read monitoring module 52, a document extraction module 54, and a keyword update module 56. When reading of content by the content display 32 is completed, the content read monitoring module 52 notifies the document extraction module 54 of the completion of reading. When the notification is received, the document extraction module 54 extracts an HTML document of content displayed by the content display 32 and delivers the HTML document to a keyword extraction module 74. The keyword update module 56 receives a keyword extracted by the keyword extraction module 74 and delivers the keyword to the keyword display 38.

The resident service or the application 70 includes a keyword dictionary 72, the keyword extraction module 74, and a keyword storage 76. The keyword extraction module 74 analyzes an HTML document received from the document extraction module 54 to extract characteristic keywords. The keyword dictionary 72 stores many words used for keyword extraction.

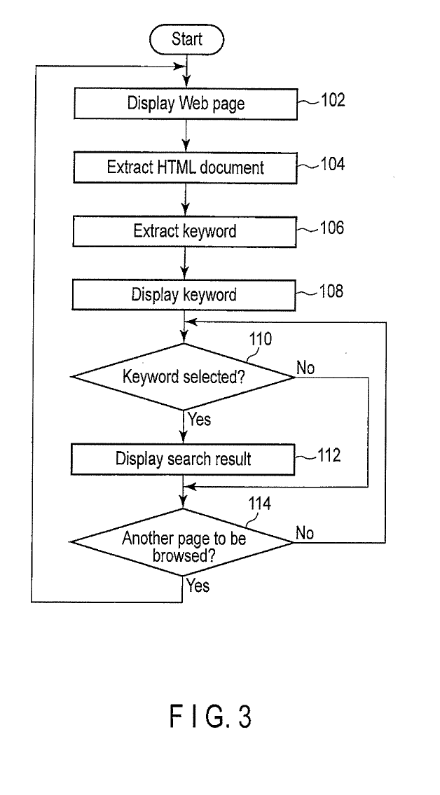

An example of a web page browsing operation by the system in FIG. 2 will be described with reference to the flow chart in FIG. 3.

The user specifies the URI by using an input interface such as the keyboard 4 or the touch pad 5. The URI specifying module 36 provides the URI to the HTML document acquisition module 34. The HTML document acquisition module 34 acquires an HTML document corresponding to the URI from the web server 22. The content display 32 analyzes the HTML of the acquired document and reproduces a layout of the acquired web page to display the screen of the web page in the LCD 6 (block 102).

The URI can be embedded in a web page and in addition to inputting the URI by using the keyboard 4, the user can also specify the URI embedded in the displayed web page by selecting the URI by, for example, the pointing device 5. That is, the user can successively browse web pages as if to follow links from some web page to another web page. The content display program 30 can contain a plurality of tabs and a new web page screen may be displayed in a new tab.

The content read monitoring module 52 monitors the progress of the display of content displayed by the content display 32. If the content read monitoring module 52 detects that the display of all content to be displayed is completed, the content read monitoring module 52 notifies the HTML document extraction module 54 of the completion of the display and also sends the content thereto. When the notification that the display of content is completed is received from the content read monitoring module 52, the HTML document extraction module 54 extracts an HTML document of the content and delivers the HTML document to the keyword extraction module 74 (block 104).

In block 106, the keyword extraction module 74 analyzes the HTML document received from the HTML document extraction module 54 and currently being browsed, thereby extracting characteristic keywords. More specifically, the keyword extraction module 74 extracts text deemed to be the body from the HTML document and decomposes the text into morphemes as minimum units having meanings as a language based on words contained in the keyword dictionary 72. The keyword dictionary 72 stores words enabling to distinguish, for example, the part of speech of morphemes. Each morpheme of the text decomposed by the morphological analysis serves as an extracted keyword. For example, the extracted keywords are sorted in descending order of score. The score represents, for example, the degree of frequency at which an extracted keyword appears. The keywords may be sorted not only in descending order of the score but also in ascending order of the score. Alternatively, the extracted keywords may be arranged in the order in which they are extracted without sorting the extracted keywords. Further, the extracted keywords may be arranged in chronological order of extraction or in alphabetical order.

The extracted keywords are stored in the keyword storage 76 and also delivered to the keyword update module 56. The keyword storage 76 associates and records tab information to identify on which tab the content from which the keyword is extracted is displayed, the date/time (extraction time) when the tab information is extracted, and the extracted keyword. All keywords extracted from a document may be recorded or the upper limit of keywords may be provided.

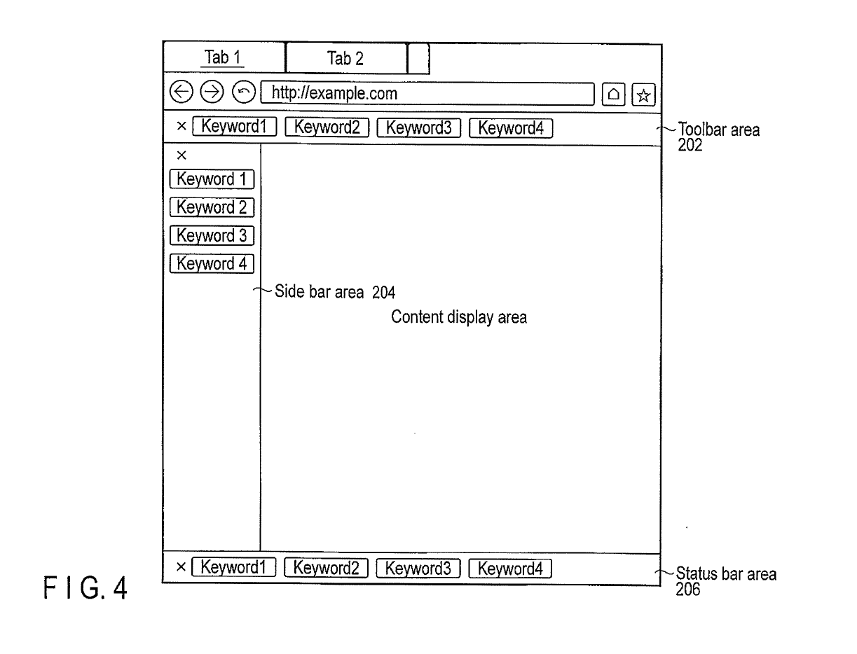

The keyword update module 56 delivers keyword data to the keyword display 38 to cause a predetermined area in the window displayed by the content display program 30, for example, a status bar area 206, a toolbar area 202, or a side bar area 204 to display the keywords (block 108). FIG. 4 shows an example of the keyword display. Each keyword is displayed as a selectable button and displayed as a keyword bar adjacent to the status bar, toolbar, or side bar. As many keywords as can be displayed in the area may be displayed or a predetermined number of keywords may be displayed. Alternatively, the keywords may scrollably be displayed by displaying scroll buttons. The keywords may be displayed in descending order of score as described above or in alphabetical order. The keywords can be displayed in any of the above three areas, but when content is viewed by scrolling, the cursor is expected to be positioned in a lower position of the content display area when viewing is completed and thus, if the status bar area is caused to display the keywords, the keyword can be selected by a slight movement of the cursor, leading to good operability.

Keywords are not limited to keywords extracted from the currently displayed content. A mode in which keywords extracted in the past and stored in the keyword storage 76 are displayed may be provided. Alternatively, a server to monitor browsing states of many users may be provided to selectively display “recommended” keywords used by many users or “rapidly rising” keywords whose use is rapidly rising.

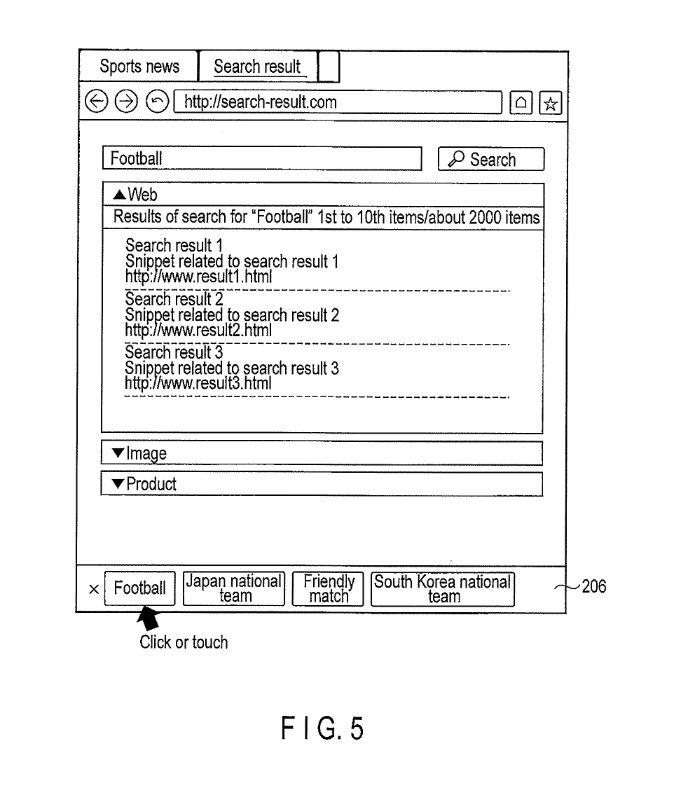

The user selects one of keywords displayed in the status bar area 206, the toolbar area 202, or the side bar area 204. If, in block 110, the selection (touch or click) of a button in which a keyword is displayed is detected, the URI specifying module 36 is notified of a URI that displays a search result corresponding to the keyword. The HTML document acquisition module 34 acquires an HTML document corresponding to the search result from the search server 24 and displays the HTML document in the content display 32 (block 112). The content display program 30 has a plurality of tabs to display content and displays a browsing page and a search result page as separate tabs. FIG. 5 shows an example of the search result page. For convenience of description, an example in which keyword bars are displayed in the status bar area 206 is shown in diagrams below. The search result shows a list of content containing a keyword and includes the title of the web page, snippets, and URI of the content.

The search result page itself is a web page and thus also a target of keyword extraction, but keywords extracted from the search result page are likely to be the same as the list of content and such keywords do not have to be extracted. Therefore, processing that determines to exclude search result pages from pages from which keywords are extracted based on URI information is performed. However, a keyword extracted from the page (tab) browsed immediately before may be read from the content storage 76 and displayed in the search result page. FIG. 5 shows an example in which a keyword extracted from the page browsed immediately before is displayed in the search result page.

In block 114, if an instruction to browse another page by direct input of the URI or clicking is detected, the processing returns to block 102.

According to the first embodiment, as described above, when content is displayed by the content display program 30, keywords are extracted from the content and the extracted keywords are displayed in the predetermined area 202, 204, or 206 in a display window of the content by the content display program 30. Therefore, the content and keywords are displayed in the same screen and the displayed keywords naturally catch user's attention, making it easier for the user to browse related web pages by selecting keywords.

Other embodiments will be described below. In the description of other embodiments, the same reference numerals are attached to the same units as those in the first embodiment and a description thereof is omitted.

### Second Embodiment

The appearance, the system block diagram, and the flow chart are the same as those in the first embodiment shown in FIGS. 1, 2, and 3.

The second embodiment is different from the first embodiment in processing content of a keyword update module 56 and a keyword display 38 and a screen display. Thus, the second embodiment achieves all effects of the first embodiment. In the first embodiment, the user interface such as the status bar area 206, toolbar area 202, and side bar area 204 of the content display program 30 can be used and the content display 32 displays extracted keywords in these areas, but these areas may not be available depending on the content display program 30. The second embodiment is intended to cope with a case in which these areas are not available to the user. The content display area is caused to display keyword bars by rewriting HTML of content.

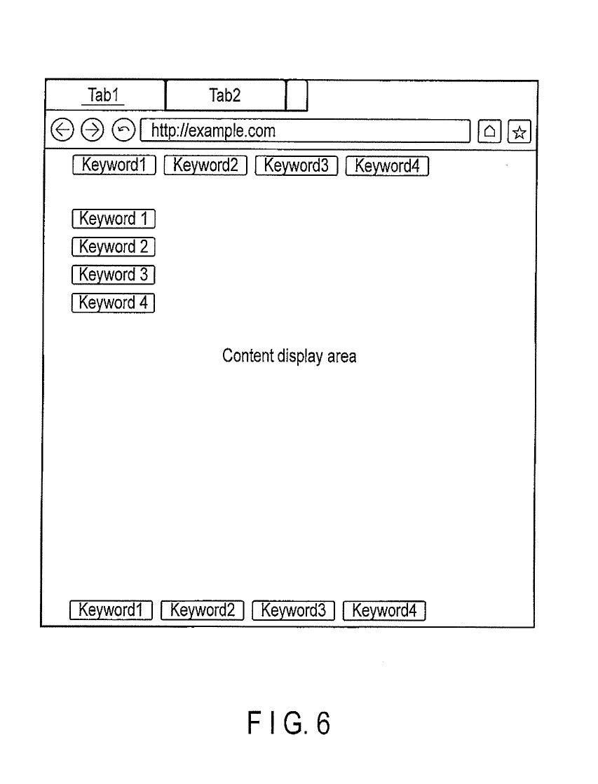

The keyword update module 56 creates an HTML tag that displays the status bar 206 or the like containing keywords and delivers the created HTML tag to the keyword display 38. The keyword display 38 adds the HTML tag to an HTML document of a browsing page to display, as shown in FIG. 6, an imaginary status bar at the top or bottom of the browsing page. Each keyword is displayed, like in the first embodiment, as a selectable button. If the button is selected, like in FIG. 5, the search result page corresponding to the keyword is displayed.

According to the second embodiment, keywords related to content can be displayed by adding the extracted keywords to an HTML document of the browsing page even if the content display program 30 does not allow the use of the user interface such as the status bar area 206, toolbar area 202, or side bar area 204. Moreover, only an HTML tag is added, so that the design and the like can be made common among the different content display programs 30.

### Third Embodiment

The third embodiment is a modification of the screen display of the first embodiment. Thus, the third embodiment achieves all effects of the first embodiment. In the third embodiment, when a content display program 30 sets a plurality of tabs to display content, keywords are also displayed corresponding to each tab.

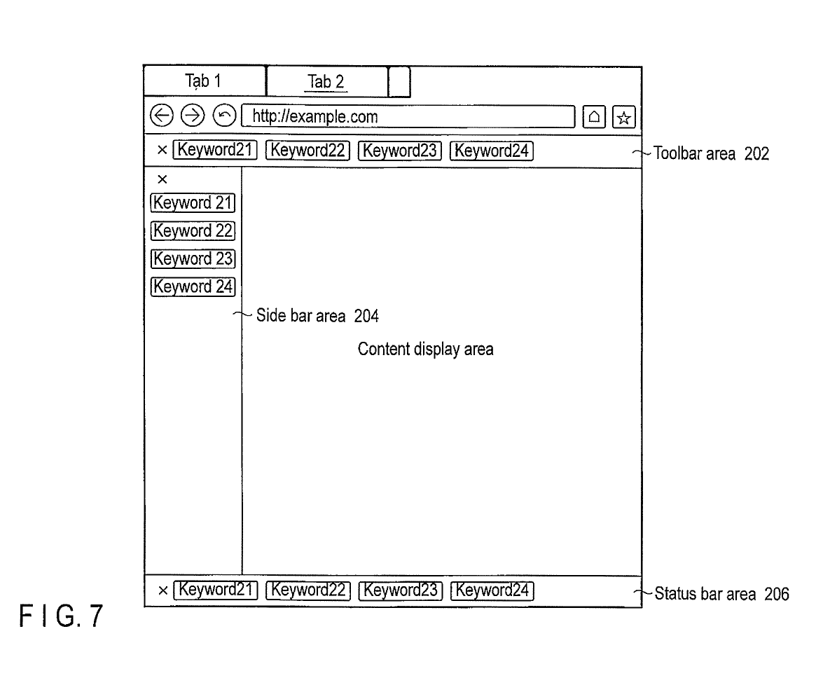

If the status bar area 206 or the like is created for each tab when, like in the first embodiment, the status bar area 206 or the like of the content display program 30 is available, keywords corresponding to each tab are displayed. If one status bar area 206 or the like is created for the whole content display program 30, keywords extracted for each tab are stored in the keyword storage 76 together with the ID of each tab. The keyword display 38 monitors for a tab switching event caused when the user switches the tab and displays, as shown in FIG. 7, keywords corresponding to “tab 2” if “tab 1” is switched to “tab 2”.

If, like in the second embodiment, an imaginary status bar is displayed in the status bar area 206 or the like by adding an HTML tag to an HTML document, an imaginary status bar is created for each tab and keyword bars are switched if the tab is switched. Thus, the third embodiment does not have to be modified.

According to the third embodiment, keywords corresponding to content of a web page can be displayed for each tab and thus, if the tab is switched and the browsing page is switched, keywords are also switched, increasing convenience of the user who performs a keyword search.

### Fourth Embodiment

The fourth embodiment is a modification of the screen display of the first to third embodiments. Thus, the fourth embodiment achieves all effects of the first to third embodiments.

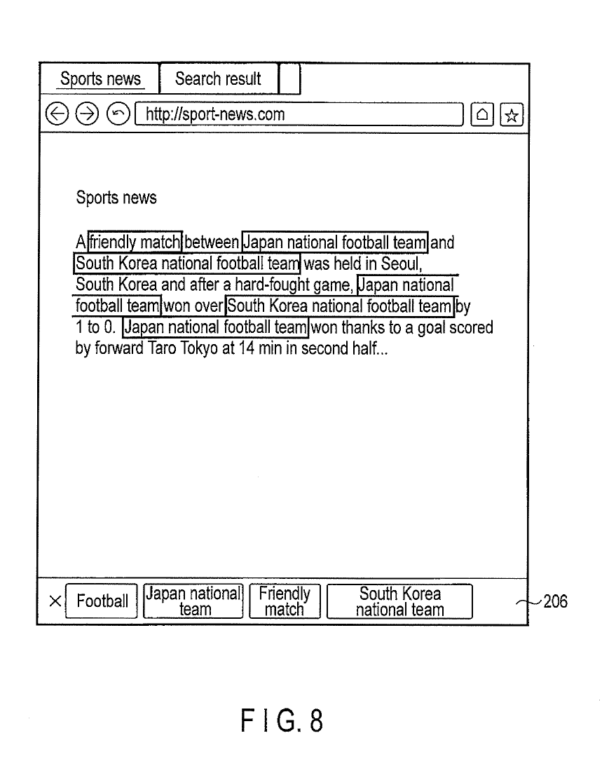

FIG. 8 shows a display example of the browsing page according to the fourth embodiment. A web page is displayed in the content display area and extracted keywords are displayed in, for example, the status bar area 206. If extracted keywords are displayed in the status bar area 206, the content display program 30 automatically highlights each extracted keyword contained in a web page displayed in the content display area. Highlighting may be any change in appearance such as changing the background color, the character color or the like of each keyword. Highlighting of the keyword occurs by rewriting an HTML document displayed by the content display 32. If there are so many extracted keywords that all keywords cannot be displayed in the status bar area 206, only displayed keywords may be highlighted or all extracted keywords including keywords that are not displayed may be highlighted.

According to the fourth embodiment, highlighting keywords extracted from content being browsed in the content makes clear from which portion of the browsing page each keyword is extracted and the judgment when selecting the keyword to be used for a search is facilitated, increasing user convenience.

### Fifth Embodiment

The fifth embodiment is also a modification of the screen display of the first to third embodiments. Thus, the fifth embodiment achieves all effects of the first to third embodiments. The fifth embodiment also relates to highlighting of keywords. While extracted keywords in the browsing page are automatically highlighted in the fourth embodiment, the user can specify keywords to be highlighted in the fifth embodiment. If the user performs a predetermined operation on some keyword the keyword is highlighted.

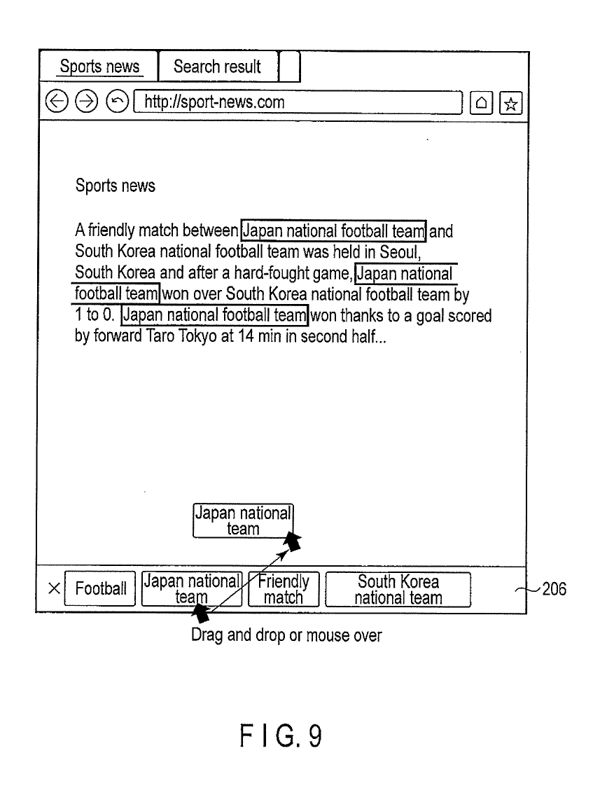

FIG. 9 shows a display example of the browsing page according to the fifth embodiment. A web page is displayed in the content display area and extracted keywords are displayed in, for example, the status bar area 206. As described in the first embodiment, if one of extracted keyword buttons displayed in the status bar area 206 is clicked or touched, the browsing page is switched, as shown from FIG. 4 to FIG. 5, to a search result page display based on the keyword. However, if one of extracted keywords displayed in the status bar area 206 is dragged and dropped onto some active tab or the mouse is simply placed over one of extracted keywords, as shown in FIG. 9, the display of the browsing page continues without being switched to a search result page and the keyword dragged and dropped in the browsing page or over which the mouse is placed is highlighted.

Whether the currently active tab is the web page being browsed or a search result page can be determined based on information available to the content display program 30 such as URI information of the active tab and ID information of the tab. This determination is not needed for the method by which, like in the second embodiment, the status bar or the like is displayed by rewriting an HTML document and adding a tag because content of the tab content and keywords match.

According to the fifth embodiment, like the fourth embodiment, keywords extracted from content being browsed is highlighted in the content, thereby making clear from which portion of the browsing page each keyword is extracted. The judgment when selecting the keyword to be used for a search is facilitated so that user convenience is increased. Further, since keywords are highlighted by corresponding to a user's operation, instead of lighting all keywords, user convenience is further increased.

### Sixth Embodiment

The sixth embodiment is a modification of the keyword search of the first to fifth embodiments. Thus, the sixth embodiment achieves all effects of the first to fifth embodiments.

In the first to fifth embodiments, the search of a single keyword is described. However, if an AND search of a plurality of keywords is performed, search targets are narrowed down and desired information can be obtained more frequently. The sixth embodiment is a modification of the first to fifth embodiments to realize an AND search.

As described in the first embodiment, if one keyword is selected while keywords are displayed in the browsing page, a search result page corresponding to the keyword is displayed. If, for example, the keyword “Football” is selected, a search result page as shown in FIG. 5 is displayed.

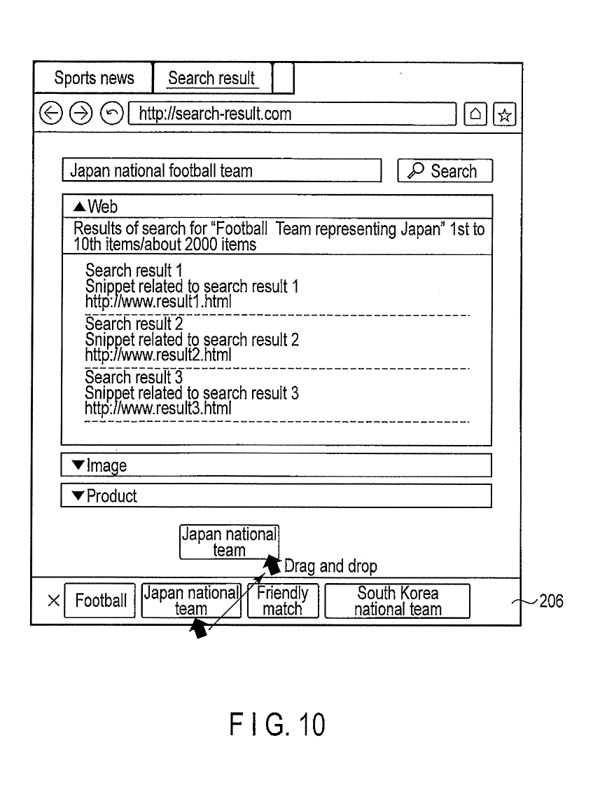

If, while the search result page of the keyword “Football” is displayed, one of keywords other than “Football” displayed in the status bar area 206 and extracted from the browsing page immediately before is dragged and dropped onto a search result page of an active tab, an AND search of both keywords is performed. If, for example, the keyword “Japan National Team” is dragged and dropped while the search result page of the keyword “Football” in FIG. 5 is displayed, an AND search of the keywords “Football” and “Japan National Team” is performed and a search result page as shown in FIG. 10 is displayed.

If the third keyword (for example, “friendly match”) is further dragged and dropped in the state in FIG. 10, an AND search of the three keywords may be performed or an AND search of the first and third keywords may be performed.

Whether the currently active tab is the web page being browsed or a search result page can be determined based on information available to the content display program 30 such as URI information of the active tab and ID information of the tab. According to the method of, like the second embodiment, displaying the status bar or the like by rewriting an HTML document and adding a tag, extracted keywords are not displayed in the search result page. Thus, extraction results immediately before are held to display keywords in the search result page and when a search result page is displayed, the HTML document is rewritten and keywords are added to display the search result page.

According to the sixth embodiment, an AND search of the keyword that has derived a search result page and a keyword displayed together with the search result page can be performed by performing a simple operation on the keyword displayed together with the search result, increasing user convenience. The operation of an AND search is not limited to dragging and dropping and a text box into which text can be input may be provided so that the user can specify the keyword for the AND search.

### Seventh Embodiment

The seventh embodiment is also a modification of the keyword search of the first to fifth embodiments. Thus, the seventh embodiment achieves all effects of the first to fifth embodiments.

In the sixth embodiment, one keyword is specified in the browsing page, a search is performed using the specified single keyword and then, if an additional keyword is specified in a search result page, an AND search is performed. Thus, a search using a single keyword is first performed and an AND search is performed in the second search or thereafter. In the seventh embodiment, by contrast, a plurality of keywords can be specified in the browsing page and an AND search of specified keywords is performed also in the first search.

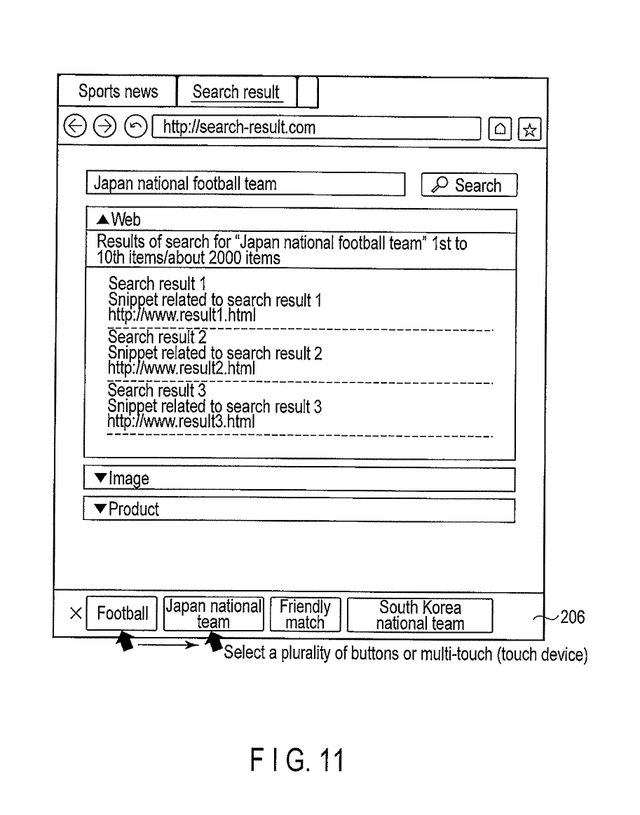

A web page is displayed in the content display area and extracted keywords are displayed in, for example, the status bar area 206. If a plurality of extracted keyword buttons displayed in the status bar area 206 is selected, as shown in FIG. 11, the display switches to the search result page display of an AND search with the selected keywords (here, Football and Japan National Team). One method of selecting a plurality of keywords is to click on the first keyword and drag the first keyword to drop the first keyword on the second keyword. If the touch device is compliant with multi-touching, two keywords may be touched simultaneously.

According to the seventh embodiment, an AND search can be performed quickly by performing a simple operation on a plurality of keywords displayed in the browsing page, increasing user convenience.

### Eighth Embodiment

The eighth embodiment is also a modification of the keyword search of the first to fifth embodiments. Thus, the eighth embodiment achieves all effects of the first to fifth embodiments.

As described in the first embodiment, if one keyword is selected while keywords are displayed in the browsing page, a search result page corresponding to the keyword is displayed. If, for example, the keyword “Football” is selected, a search result page as shown in FIG. 5 is displayed.

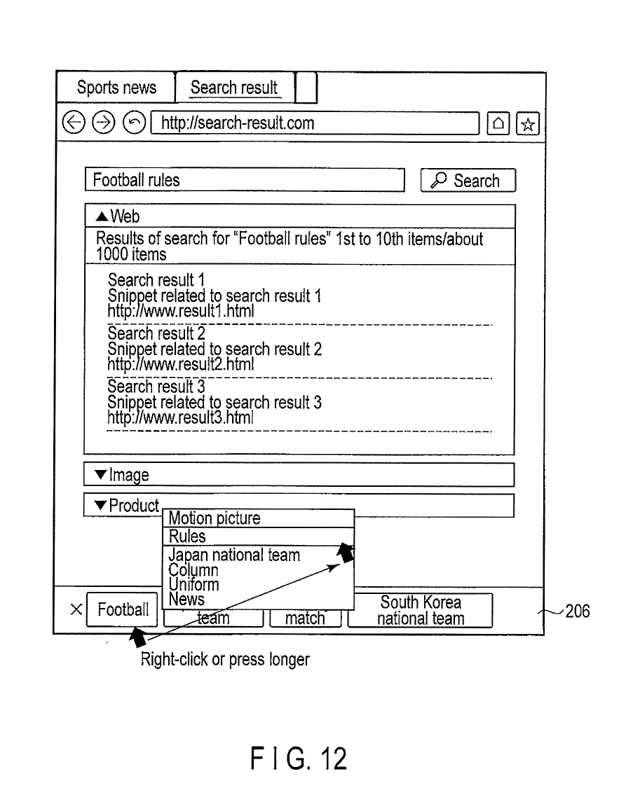

If, while the search result page of the keyword “Football” is displayed, “Football” among keywords extracted from the browsing page immediately before and displayed in the status bar area 206 is right-clicked, keywords related to “Football” are displayed in the form of context menu. If the user selects one of keywords in the menu, an AND search of both keywords is performed. If, for example, the keyword “Rules” in the related keyword menu is selected while the search result page of the keyword “Football” in FIG. 5 is displayed, an AND search of the keywords “Football” and “Rules” is performed and a search result page as shown in FIG. 12 is displayed. If a plurality of keywords is selectable from the related keyword context menu, an AND search of three keywords or more may be performed or an AND search of the first and third keywords may be performed.

Also according to the eighth embodiment, an AND search can be performed by performing a simple operation on a displayed keyword, increasing user convenience.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The present invention is not limited to the above embodiments as they are and may be embodied by modifying structural elements without deviating from the scope thereof in the working stage. The present embodiment can also be embodied in the form of a computer program realizing the above information processing apparatus and information processing method or in the form of a storage medium storing the program. Moreover, various inventions can be formed by appropriately combining a plurality of structural elements disclosed by the above embodiments. For example, some structural elements may be deleted from all structural elements shown in an embodiment. Further, structural elements extending over different embodiments may appropriately be combined. Keywords to be displayed are not limited to keywords extracted from the content being browsed and keywords searched by the user in the past or “recommended” keywords currently used by many users may also be displayed. In addition, a plurality of search engines may be provided so that the search engine to be used can be selected. The language of keywords to be extracted may be made selectable.

What is claimed is:

1. An information processing apparatus comprising:
a content display configured to display a content;
an extraction module configured to extract a keyword from the content displayed by the content display; and
a keyword display configured to display the keyword extracted by the extraction module in a content display window.

2. The apparatus of claim 1, wherein the keyword display is configured to display the keyword in a toolbar area, a status bar area, or a side bar area of the content display window.

3. The apparatus of claim 1, wherein the keyword display is configured to display the keyword in a content display area of the content display window.

4. The apparatus of claim 1, wherein the content display comprises tabs capable of displaying the content, one of the tabs being active, and
the keyword display is configured to display the keyword in a display window of the active tab of the content display.

5. The apparatus of claim 1, wherein the content display is configured to highlight the keyword extracted by the extraction module in the content.

6. The apparatus of claim 1, wherein the keyword display is configured to display keywords, and
if one of the keywords is dragged and dropped or a mouse-over operated, the content display is configured to highlight the operated keyword in the content.

7. The apparatus of claim 1, wherein the keyword display is configured to display keywords,
the apparatus further comprising a search result display configured to display, if one of the keywords is selected, a search result of performing a search based on the selected keyword in the display window of the content.

8. The apparatus of claim 7, wherein, if two or more of the keywords are selected, the search result display is configured to display the search result of performing an AND search based on the two or more selected keywords in the display window of the content.

9. The apparatus of claim 7, wherein, if a drag and drop operation of one of the keywords is performed while the search result is displayed, the search result display is configured to display the search result of performing an AND search based on the operated keyword and the selected keyword in the display window of the content.

10. The apparatus of claim 7, wherein, if one of the keywords is specified while the search result is displayed, the search result display is configured to display a list of keywords related to the specified keyword and to display the search result of performing an AND search based on the keyword specified from the list of keywords and the selected keyword in the display window of the content.

11. An information processing method, comprising:
displaying a content;
extracting a keyword from the displayed content; and
displaying the extracted keyword in a content display window.

12. A non-transitory computer-readable storage medium storing computer-executable instructions that, when executed, cause a computer to:
display a content;
extract a keyword from the displayed content; and
display the extracted keywords in a content display window.
